(19) United States
(12) Patent Application Publication
(10) Pub. No.: US 2012/0008157 A1
(43) Pub. Date: Jan. 12, 2012

(54) IMAGE FORMING APPARATUS AND NETWORK SYSTEM

(75) Inventor: Jun Sakakibara, Tokyo-to (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/177,658

(22) Filed: Jul. 7, 2011

Related U.S. Application Data
(60) Provisional application No. 61/362,081, filed on Jul. 7, 2010.

(51) Int. Cl. G06K 15/02

(52) U.S. Cl. 358/1.13

(57) ABSTRACT

According to one embodiment, an image reading apparatus including a first reading section configured to photoelectrically convert and output image information on a first surface of an original, a second reading section configured to photoelectrically convert and output image information on a second surface located on a rear surface of the first surface of the original, and a multiplexing and transfer section configured to multiplex an output signal output by the first reading section and an output signal output by the second reading section and output a multiplexed signal to a single image processing section.

### CROSS-REFERENCE TO RELATED APPLICATIONS

This application is based upon and claims the benefit of priority from: U.S. Provisional Application No. 61/362,081 filed on Jul. 7, 2010, the entire contents of each of which are incorporated herein by reference.

### FILED

Embodiments described herein relate generally to an image reading apparatus and to use data read with the apparatus.

### BACKGROUND

A reading section (a scanner) is attached to an MFP (an image forming apparatus referred to as Multi-Functional Peripheral) in most cases.

In the reading section (the scanner), a system that can read information on the front and the rear of an original (a reading object) in one reading operation is put to practical use.

### BRIEF DESCRIPTION OF THE DRAWINGS

FIG. 1 is an exemplary diagram showing an example of an MFP according to an embodiment;

FIG. 2 is an exemplary diagram showing an example of an arrangement of image sensors of reading section of the MFP according to an embodiment;

FIG. 3 is an exemplary diagram showing an example of an image signal processing section of the MFP according to an embodiment;

FIG. 4 is an exemplary diagram showing an example of a method of image signal processing of the MFP according to an embodiment;

FIG. 5 is an exemplary diagram showing an example of a method of image signal processing of the MFP according to an embodiment;

FIG. 6 is an exemplary diagram showing an example of a 4-CCD image sensor of the MFP according to an embodiment; and

FIG. 7 is an exemplary diagram showing an example of a method of image signal processing of the MFP according to an embodiment.

### DETAILED DESCRIPTION

In general, according to one embodiment, an image forming apparatus comprising: a first reading section configured to photoelectrically convert and output image information on a first surface of an original; a second reading section configured to photoelectrically convert and output image information on a second surface located on a rear surface of the first surface of the original; and a multiplexing and transfer section configured to multiplex an output signal output by the first reading section and an output signal output by the second reading section and output a multiplexed signal to a single image processing section.

Embodiments will now be described hereinafter in detail with reference to the accompanying drawings.

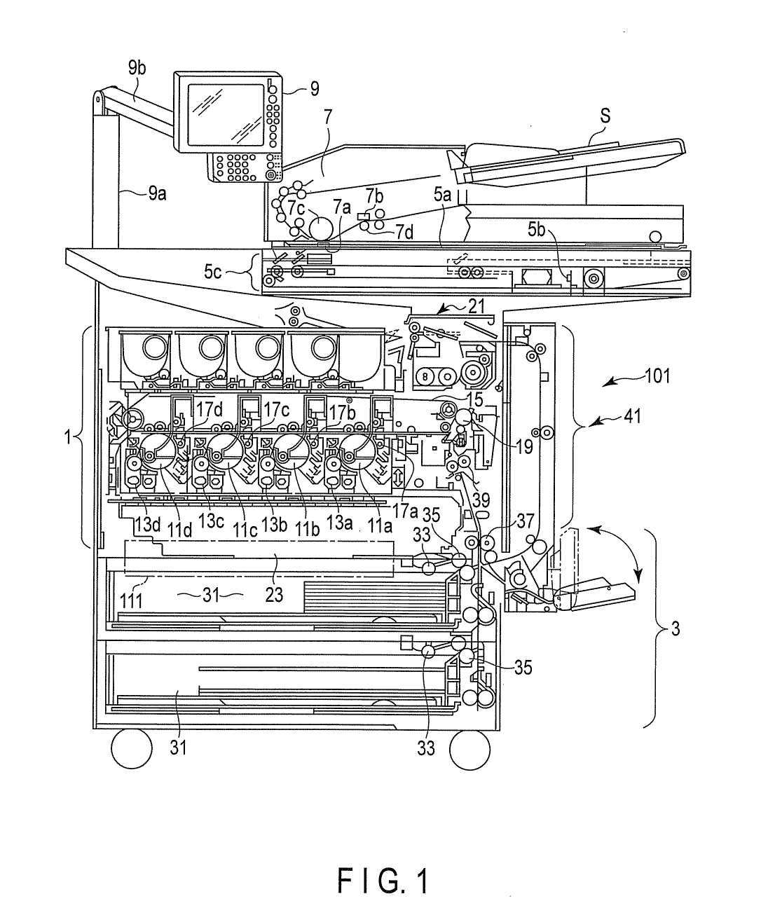

FIG. 1 schematically shows an MFP (Multi-Functional Peripheral) to which the embodiment is able to apply.

An MFP 101 includes an image forming section (a printer section) 1 for outputting image information as an output image which is referred to as a hard copy or a print out, a sheet feeder 3 to supply a sheet medium having an optional size, which is used for an image output, to the image forming section 1, a scanner section 5 to provide image data of an original to the image forming section 1, and a control section 111 to control the MFP 101.

Moreover, the scanner section 5 integrally has an automatically-document feeder (ADF) 7 which conveys the original to a reading position on the scanner section 5.

The ADF 7 includes a reading sensor A (first) 7a and a sensor B (second) 7b configured to convert image information of an original into an electric signal. The reading sensor A converts image information on a first surface of the original into an electric signal. The reading sensor B converts image information on a second surface, which is the rear surface of the first surface, of the original into an electric signal.

In the reading sensor A (when there is no movement of an original), “black reference information” and “white reference information” for providing reference values used when the reading sensor A converts image information into an electric signal are located in a position to which illumination light can be provided. For example, the “black reference information” and the “white reference information” are located in a back guide 7c.

In the reading sensor B (when there is no movement of an original), “black reference information” and “white reference information” for providing reference values used when the reading sensor B converts image information into an electric signal are located in a position to which illumination light can be provided. For example, the “black reference information” and the “white reference information” are located in a back guide 7d.

The scanner section 5 includes a third reading sensor 5b in a predetermined position below a document table 5a and on the inside of the scanner section 5. The third reading sensor 5b receives image information of an original on the document table 5a trough an illuminating system 5c.

A control panel 9 to input an instruction for starting image formation in the image forming section 1 and starting to read image information of the original through the scanner section 5 is placed in a strut 9a fixed to the image forming section 1 and a swing arm 9b in a corner at a left or right side behind the scanner section 5.

The image forming section 1 includes first to fourth photoconductive drums 11a to 11d for holding latent images, developers 13a to 13d for supplying a toner to the latent images on the photoconductive drums 11a to 11d to develop toner images, a transfer belt 15 for holding the toner images transferred from the photoconductive drums 11a to 11d in order, cleaners 17a to 17d for cleaning the individual photoconductive drums 11a to 11d, a transfer roller 19 for transferring the toner image held by the transfer belt 15 onto a sheet medium, a fuser 21 for fixing the toner image transferred to the sheet medium by the transfer roller 19 onto the sheet medium, and an exposing device 23 for forming latent images on the photoconductive drums 11a to 11d.

The first to fourth developers 13a to 13d store toners having optional colors of Y (yellow), M (magenta), C (cyan) and Bk (black) which are used for obtaining a color image by a subtractive process and visualize a latent image held by each of the photoconductive drums 11a to 11d in any of the colors Y, M, C and Bk. The respective colors are determined in predetermined order corresponding to an image forming process or a characteristic of the toner.

The transfer belt 15 holds the toner images having the respective colors which are formed by the first to fourth photoconductive drums 11a to 11d and the corresponding developers 13a to 13d in order (of the formation of the toner images).

The sheet feeder 3 supplies the sheet medium to be transferred the toner image by the transfer roller 19.

Cassettes positioned in a plurality of cassette slots 31 store sheet media having optional sizes. Depending on an image forming operation, a pickup roller 33 takes the sheet medium out of the corresponding cassette. The size of the sheet medium corresponds to a size of the toner image formed by the image forming section 1.

A separating mechanism 35 prevents at least two sheet media from being taken out of the cassette by the pickup roller 33.

A delivery roller 37 feeds the sheet medium separated to be one sheet medium by the separating mechanism 35 toward an aligning roller 39.

The aligning roller 39 feeds the sheet medium to a transfer position in which the transfer roller 19 and the transfer belt 15 come in contact with each other in a timing for transferring the toner image from the transfer belt 15 by the transfer roller 19.

The fuser 21 feeds the output image to a stocker 47 positioned in a space between the scanner section 5 and the image forming section 1.

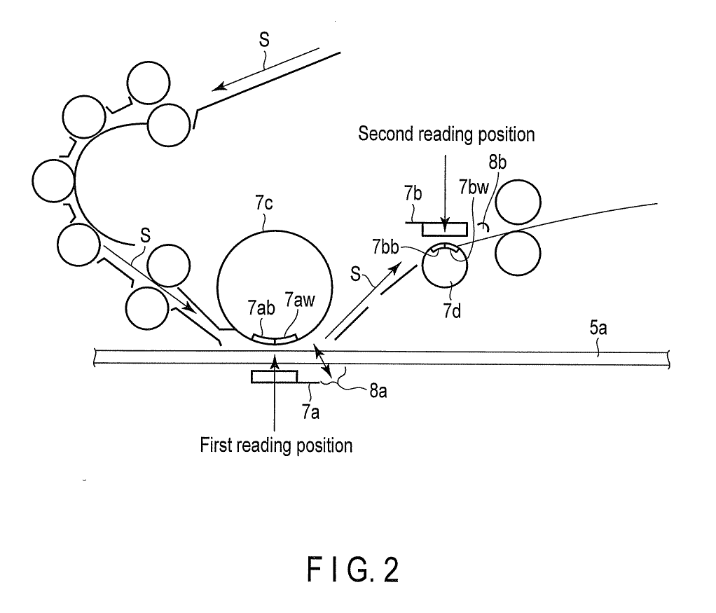

FIG. 2 is a diagram showing the vicinity of the first and second reading sensors of the ADF shown in FIG. 1.

The reading sensor A (first) 7a can read, in a position opposed to the back guide 7c, image information from an original S moving to the document table 5a of the scanner section 5. The reading sensor B (second) 7b can read image information from the moving original S in a position opposed to the back guide 7d.

The back guide 7c includes “black reference information” 7ab and “white reference information” 7aw. The “black reference information” 7ab and the “white reference information” 7aw can be located independently from the back guide 7c. An illuminating mechanism 8a configured to provide the reading sensor A (first) 7a with light reflected on the “black reference information” 7ab and the “white reference information” 7aw is located near the back guide 7c or the “black reference information” 7ab and the “white reference information” 7aw.

The back guide 7d includes “black reference information” 7bb and “white reference information” 7bw. The “black reference information” 7bb and the “white reference information” 7bw can be located independently from the back guide 7d. An illuminating mechanism 8b configured to provide the reading sensor B (second) 7b with light reflected on the “black reference information” 7bb and the “white reference information” 7bw is located near the back guide 7d or the “black reference information” 7bb and the “white reference information” 7bw.

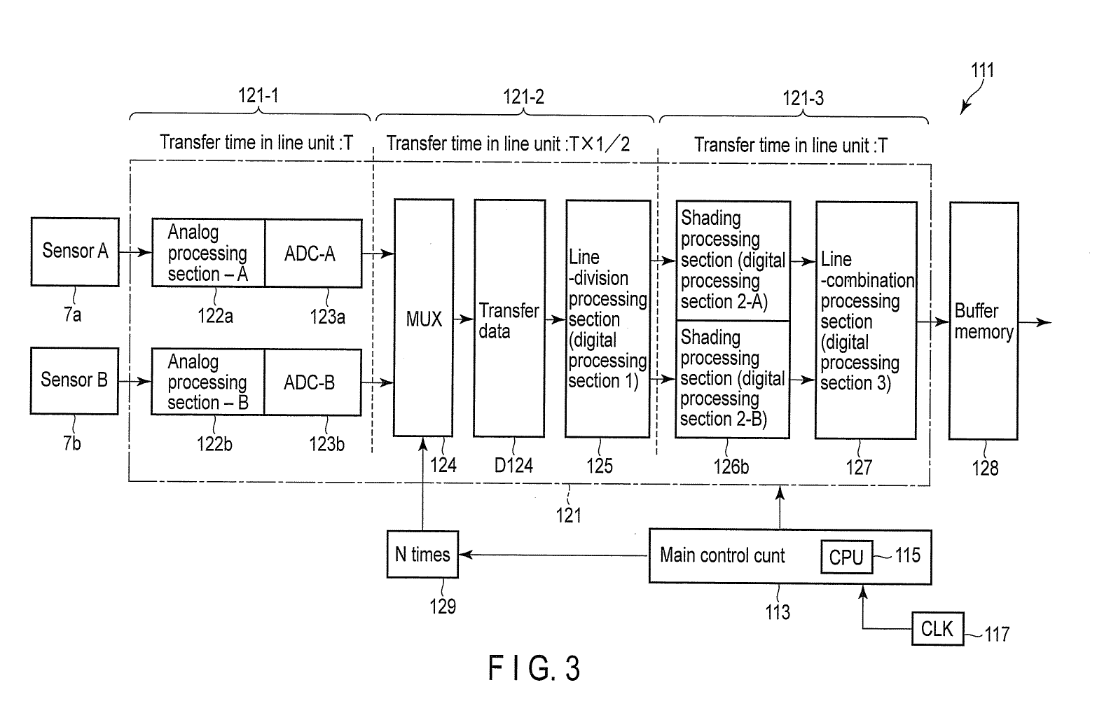

FIG. 3 shows an example of an image processing section configured to process outputs of the control section and the first and second reading sensors shown in FIG. 1.

The control section 111 includes at least a main control unit 113 including a CPU (Central Processing Unit) 115 and an image processing section 121 configured to process input signals (image information) from the reading sensors A and B. The main control unit 113 includes an input and output section (an I/O port) configured to give an input necessary for the operation of the CPU 115 and a control output by the CPU 115 to respective elements. The main control unit 113 controls the operation of the entire NFP 101. A basic clock for the CPU 115 is supplied from a clock generating section (CLK) 117.

The image processing section 121 includes a pre-processing section 121-1 configured to process signals from the sensor A (first) 7a and the sensor B (second) 7b, a transfer processing section 121-2 configured to multiplex an output from the pre-processing section 121-1 to increase transfer speed, and an output section 121-3 configured to generate, from an output transferred by the transfer processing section 121-2, image data in a page unit for print output or data transmission.

The pre-processing section 121-1 includes an analog processing section A (first) 122a configured to process a signal from the sensor A (first) 7a, an analog processing section B (second) 122b configured to process a signal from the sensor B (second) 7b, and ADCs 123a and 123b configured to convert outputs of the analog processing sections 122a and 122b into digital signals.

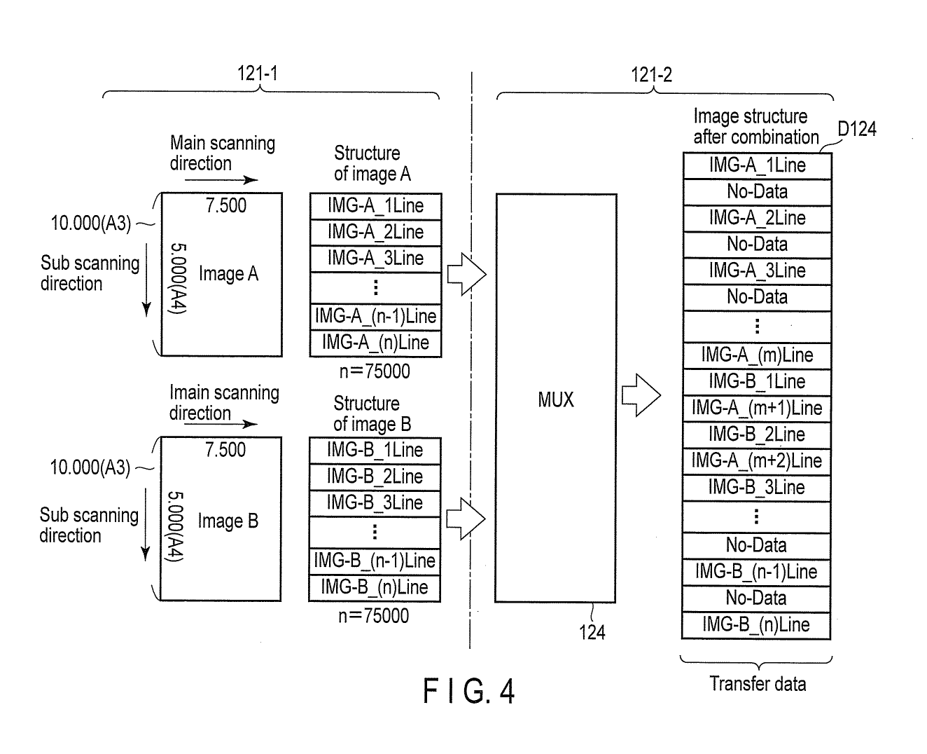

The transfer processing section 121-2 includes an MUX (multiplexer) 124 configured to multiplex digital outputs from the first ADC (ADC-A) 123a and the second ADC (ADC-B) 123b and a line-division processing section (a digital processing section 1) 125 configured to separate transferred outputs (transfer data D124) of the sensors A and B. Characteristics of the transfer data D124 output by the MUX 124 are explained later with reference to FIG. 4.

The MUX (multiplexer) 124 alternately holds and outputs (transfers) the digital outputs from the first ADC (ADC-A) 123a and the second ADC (ADC-B) 123b. In this case, it is also possible to use a method of inserting, by optimizing input timing to the MUX 124, outputs from the second ADC (ADC-B) 123b among outputs of the first ADC (ADC-A) 123a held at every other line.

The output section 121-3 includes a first shading processing section (a digital processing section 2-A) 126a and a second shading processing section (a digital processing section 2-B) 126b configured to respectively apply shading correction to digital outputs corresponding to the outputs of the sensors A and B divided by the line-division processing section (the digital processing section 1) 125 and a line-combination processing section (a digital processing section 3) 127 configured to combine the digital outputs subjected to the shading processing by the respective shading processing sections into image data in a page unit for print output or data transmission. For example, a buffer memory 128 holds the image data output by the line-combination processing section (the digital processing section 3) 127.

FIG. 4 shows an example of a relation between characteristics of the transfer data shown in FIG. 3 and respective lines of original data corresponding to the transfer data.

As explained already, an output of the sensor A 7a is image information (an image A) on a first surface of an original and an output of the sensor B 7b is image information (an image B) on a second surface (the rear surface of the first surface of the original).

The sensors are line CCD sensors extending in a main scanning direction. If reading width allows a sheet in a short side direction of the A3 size and reading resolution is, for example, 600 dpi, the sensors include about 7500 pixels. The number of times of reading (the number of lines) in a sub-scanning direction orthogonal to the main scanning direction depends on a document size. In the short side direction of the A4 size, the number of times of reading is about 5000 lines.

Image data input from the pre-processing section 121-1 to the MUX 124 of the transfer processing section 121-2 is, as shown in FIG. 4, for example, “IMG-A_1”, “IMG-A_2”, “IMG-A_3”, . . . , “IMG-A (n−1, n is a positive integer)”, and “IMG-A_(n, n is a positive integer)”, which are outputs from the sensor A, and, for example, “MG-B_1”, “IMG-B_2”, “IMG-B_3”, . . . , “IMG-B_(n−1, n is a positive integer)”, and “IMG-B_(n, n is a positive integer)”, which are outputs from the sensor B. However, the outputs from the sensor B involve a delay of “m (m is a positive integer)” lines corresponding to a distance between the reading position 7b and the reading position 7a of the sensor A shown in FIG. 2.

Therefore, multiplexed (combined) image data output by the MUX 124 in the transfer processing section 121-2 are in the order of “IMG-A_1”, “No-Data”, “IMG-A_2”, “No-Data”, “IMG-A_3”, “No-Data”, . . . , “IMG-A_(m, m is a positive integer)”, “IMG-B_1”, “IMG-A_(m+1, m is a positive integer)”, “IMG-B_2”, “IMG-A_(m+2, m is a positive integer)”, “IMG-B_3”, “No-Data”, “IMG-B_(n−2, n is a positive integer)”, . . . , “No-Data”, “IMG-B_(n−1, n is a positive integer)”, “No-Data”, and “IMG-B_(n, n is a positive integer)”.

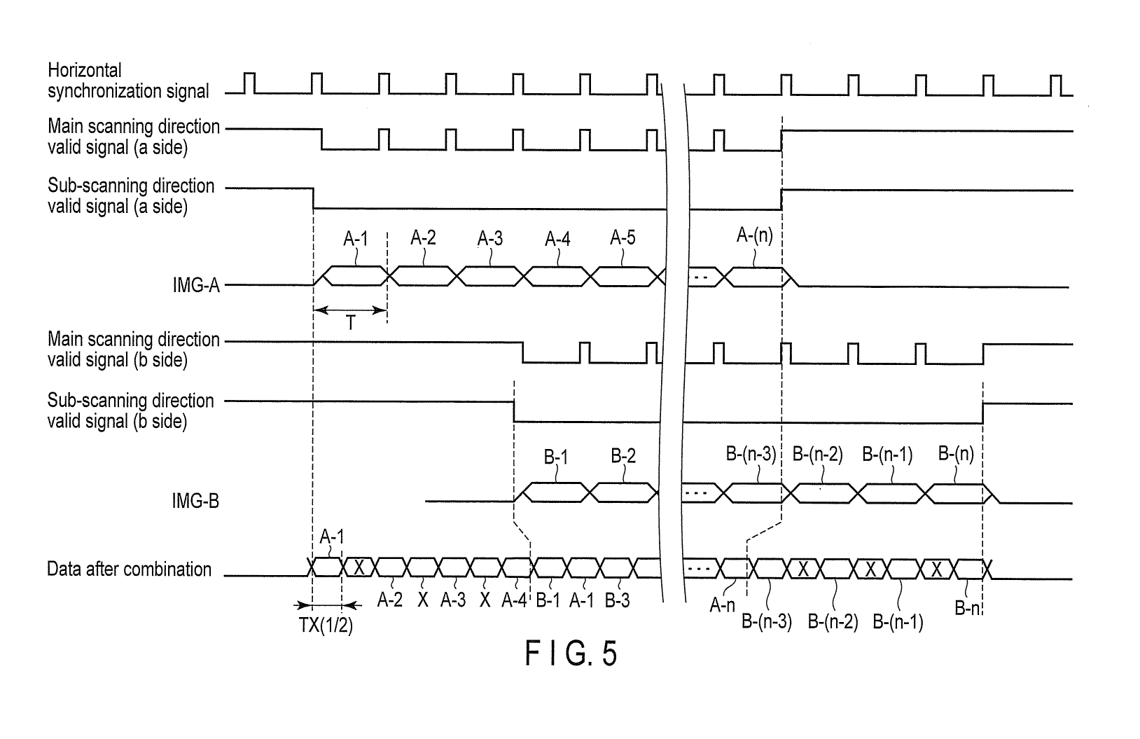

This indicates that, as shown in FIG. 5, concerning one line in the main scanning direction (no movement in the sub-scanning direction), the outputs of the sensor A and the outputs of the sensor B are located in order at timing of T/2(T×(½)) with respect to a horizontal synchronization signal T (“X” indicates No-Data). Therefore, at this point, a transfer frequency (supplied to the MUX 124) is multiplied by two (“2(1/T)”) by a multiplier 129 with respect to a frequency 1/T for the horizontal synchronization signal T.

In this way, the transfer frequency is doubled and transfer time of image data for one line in the main scanning direction is set to a half of transfer time during reading (duplex reading performed by using two sensors). This makes it possible to integrate configurations for transferring input image data to the image processing section.

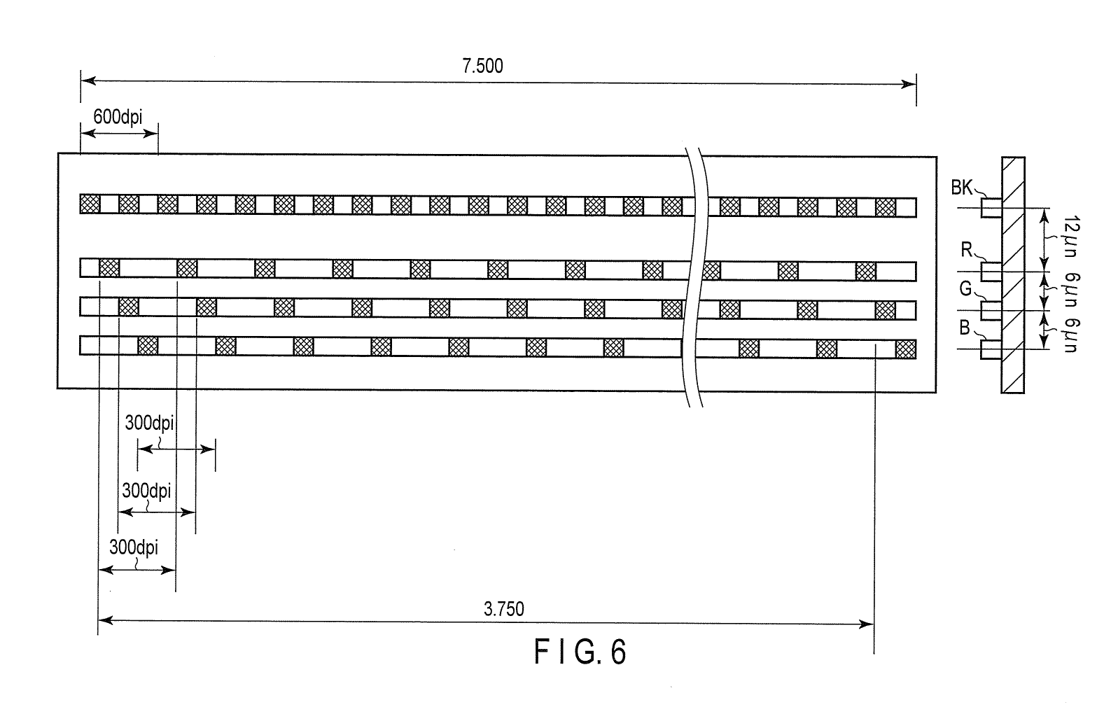

FIG. 6 shows characteristics of an array of reading pixels of the first and second reading sensors (CCD sensors) used by the ADF shown in FIG. 1.

As shown in FIG. 6, the CCD sensor includes a line sensor for monochrome (Bk) including about 7500 reading pixels (light input sections) to be capable of reading an image of a short side of the A3 size at 600 dpi and line sensors for R (Red), G (Green), and B (Blue) each including about 3750 reading pixels (light input sections) to be capable of reading an image of a short side of the A3 size at 300 dpi. Each of the line sensors for R, G, and B involves, on a light incident side of the light input section, a filter that transmits only a light component of a color corresponding to the line sensor.

If a color image is read using the CCD sensor shown in FIG. 6, reading resolution for one line in the main scanning direction is a half compared with reading resolution for monochrome (600 dpi). Therefore, if a clock is the same as a clock of reading for monochrome, the color image can be read in half time. The number of reading lines in the sub-scanning direction also only has to be a half of the number of reading lines during monochrome reading (in the case of a long side of the A3 size, about 10×10³). Therefore, if the color image is read at 300 dpi, image information of each of R, G, and B and 300 dpi monochrome image information (curtailed to a half) can be read in time same as time necessary for reading of 600 dpi monochrome image.

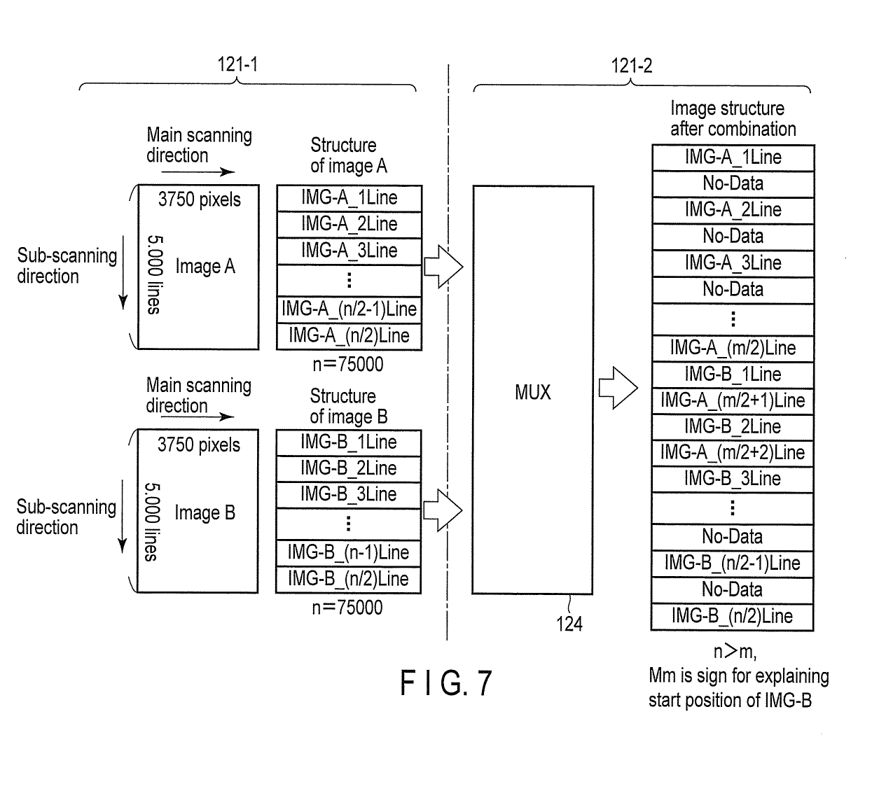

As shown in FIG. 7, if reading width (the main scanning direction) allows a sheet in a short side direction of the A3 size, since the reading resolution is 300 dpi, the CCD sensor includes about 3750 (a half compared with the example shown in FIG. 4) pixels. The number of times of reading (the number of lines) in the sub-scanning direction orthogonal to the main scanning direction depends on a document size. In a long side direction of the A3 size, the number of times of reading is about 5000 (a half compared with the example shown in FIG. 4) lines.

Therefore, image data input from the pre-processing section 121-1 to the MUX 124 of the transfer processing section 121-2 is, for example, “IMG-A_1”, “IMG-A_2”, “IMG-A_3”, . . . , “IMG-A_((n/2)−1, n is a positive integer)”, and “IMG-A_((n/2), n is a positive integer)”, which are outputs from the sensor A, and, for example, “IMG-B_1”, “IMG-B_2” “IMG-B_3”, . . . , “IMG-B_((n/2)−1, n is a positive integer)”, and “IMG-B_((n/2), n is a positive integer)”, which are outputs from the sensor B. However, as explained already, the outputs from the sensor B involve a delay for “m (m is a positive integer, n>m)” lines corresponding to a distance between the reading positions of the sensor B and the sensor A.

Therefore, multiplexed (combined) image data output by the MUX 124 in the transfer processing section 121-2 are in the order of “IMG-A_1”, “No-Data”, “IMG-A_2”, “No-Data”, “IMG-A_3”, “No-Data”, . . . , “IMG-A_((m/2), m is a positive integer)”, “IMG-B_1”, “IMG-A_((m/2)+1, m is a positive integer)”, “IMG-B_2”, “IMG-A_((m/2)+2, m is a positive integer)”, “IMG-B_3”, . . . , “No-Data”, “IMG-B_((n/2)−2, n is a positive integer)”, . . . , “No-Data”, “IMG-B_((n/2)−1, n is a positive integer)”, “No-Data”, and “IMG-B_((n/2), n is a positive integer)”.

In this way, the signal processing system that can read the 600 dpi monochrome image can be substantially used for reading of the color image at 300 dpi in common.

If the reading system described above (300 dpi×3 (R, G, B)) and the 300 dpi monochrome image signal are combined, i.e., a color image signal is complemented by a monochrome image signal, it is possible to convert the resolution of an output (color) image data into the resolution of the monochrome image signal.

If the scanner section 5 is used as a network scanner from an arbitrary user (client) PC located on the network, it is possible to read (acquire) image information on both the surfaces at high speed by using only outputs of R, G, and B from the color CCD sensor among outputs of the four CCD sensors shown in FIG. 6.

In this way, by applying this embodiment, it is possible to acquire image data with a single image processing system from an original including image information on both a first surface and a second surface, which is the rear surface of the first surface. Since (the number of) signal lines can be minimized, image data is suppressed from being affected by noise.

Data on the front surface and data on the rear surface can be considered as one data. ASICs (ICs for signal processing) can be consolidated into one ASIC.

Consequently, a circuit size of a signal processing system is reduced.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image reading apparatus comprising:
a first reading section configured to photoelectrically convert and output image information on a first surface of an original;
a second reading section configured to photoelectrically convert and output image information on a second surface located on a rear surface of the first surface of the original; and
a multiplexing and transfer section configured to multiplex an output signal output by the first reading section and an output signal output by the second reading section and output a multiplexed signal to a single image processing section.

2. The apparatus of claim 1, wherein the multiplexing and transfer section includes an MUX (multiplexer) and alternately outputs the output signal output by the first reading section and the output signal output by the second reading section.

3. The apparatus of claim 1, wherein the multiplexing and transfer section includes an MUX (multiplexer) and inserts the output signal output by the second reading section between output signals output by the first reading section.

4. The apparatus of claim 2, wherein the multiplexing and transfer section sets a frequency of a synchronization signal during transfer of the output signals output by the first reading section and the second reading section to be twice (or more) as large as a frequency during reading.

5. The apparatus of claim 2, wherein the multiplexing and transfer section sets a transfer period during transfer of the output signals output by the first reading section and the second reading section to be twice (or more) as large as a transfer period during reading.

6. The apparatus of claim 2, wherein the multiplexing and transfer section sets a transfer time during transfer of the output signals output by the first reading section and the second reading section to be half (or less) as large as a transfer time during reading.

7. The apparatus of claim 1, further comprising:
black reference information and white reference information that are references for the first reading section and the second reading section to respectively photoelectrically convert target images, the black reference information and the white reference information being independently prepared respectively for the first reading section and the second reading section.

8. The apparatus of claim 7, wherein the multiplexing and transfer section includes an MUX (multiplexer) and alternately outputs the output signal output by the first reading section and the output signal output by the second reading section.

9. A method of double side images reading comprising:
reading for first photoelectrically converting and outputting image information on a first surface of an original; and
reading for second photoelectrically converting image information on a second surface located on a rear surface of the first surface of the original and outputting the image information in order among outputs in a line unit output in the reading for first photoelectrically converting.

10. The method of claim 9, further comprising:
alternately outputting the outputs photoelectrically converted in the reading for second photoelectrically converting with the outputs photoelectrically converted in the reading for first photoelectrically converting.

11. The method of claim 9, further comprising:
inserting the outputs photoelectrically converted in the reading for second photoelectrically converting among the outputs photoelectrically converted in the reading for first photoelectrically converting.

12. The method of claim 9, wherein a frequency of a synchronization signal during transfer of the output signals respectively output in the reading for first photoelectrically converting and the reading for second photoelectrically converting is set to be twice (or more) as large as a frequency during reading.

13. The method of claim 9, wherein a transfer period during transfer of the output signals respectively output in the reading for first photoelectrically converting and the reading for second photoelectrically converting is set to be twice (or more) as large as a transfer period during reading.

14. The method of claim 9, wherein a transfer time during transfer of the output signals respectively output in the reading for first photoelectrically converting and the reading for second photoelectrically converting is set to be half (or less) as large as a transfer time during reading.

15. The method of claim 10, further comprising:
reading information of four lines in a same time with timing for the photoelectric conversion in the reading for first photoelectrically converting and the reading for second photoelectrically converting set to a half.

16. The method of claim 15, wherein a frequency of a synchronization signal during transfer of the output signals respectively output in the reading for first photoelectrically converting and the reading for second photoelectrically converting is set to be twice (or more) as large as a frequency during reading.

17. The method of claim 15, wherein a transfer period during transfer of the output signals respectively output in the reading for first photoelectrically converting and the reading for second photoelectrically converting is set to be twice (or more) as large as a transfer period during reading.

18. The method of claim 15, wherein a transfer time during transfer of the output signals respectively output in the reading for first photoelectrically converting and the reading for second photoelectrically converting is set to be half (or less) as large as a transfer time during reading.

19. An image forming apparatus comprising:
a scanner section including:
a first reading section configured to photoelectrically convert and output image information on a first surface of an original;
a second reading section configured to photoelectrically convert and output image information on a second surface located on a rear surface of the first surface of the original; and
a combining and transfer section configured to multiplex an output signal output by the first reading section and an output signal output by the second reading section and output a multiplexed signal to a single image processing section; and
an image forming section configured to form a visible image on the basis of an image signal supplied by an image processing section that holds an output from the scanner section.

20. The apparatus of claim 19, further comprising:
the image forming section forms visible images of C, M, Y, and Bk corresponding to R, G, and B, and
the scanner section reads information of four lines in a same time with timing for the photoelectric conversion by the first reading section and the second reading section set to a half.
